(19) United States
(12) Patent Application Publication
(10) Pub. No.: US 2015/0121246 A1
(43) Pub. Date: Apr. 30, 2015

(54) SYSTEMS AND METHODS FOR DETECTING USER ENGAGEMENT IN CONTEXT USING PHYSIOLOGICAL AND BEHAVIORAL MEASUREMENT

(71) Applicant: The Charles Stark Draper Laboratory, Inc., Cambridge, MA (US)

(72) Inventors: Joshua Poore, Somerville, MA (US); Jana Schwartz, Somerville, MA (US); Andrea Webb, Medford, MA (US); Meredith Cunha, Brighton, MA (US)

(73) Assignee: The Charles Stark Draper Laboratory, Inc., Cambridge, MA (US)

(21) Appl. No.: 14/523,366

(22) Filed: Oct. 24, 2014

Related U.S. Application Data
(60) Provisional application No. 61/895,906, filed on Oct. 25, 2013.

(51) Int. Cl. G06F 3/0484

(52) U.S. Cl. CPC G06F 3/04842
USPC 715/745

(57) ABSTRACT

The present disclosure is directed to an engagement-adaptive system. The system includes a content delivery module configured to deliver content to a user, a context logger configured to associate events in the delivered content with temporal locations in a first time-series. The system also includes an indicator measurement module configured to measure at least one engagement indicator and associate the measurements with temporal locations in a second time-series. The system includes an engagement analysis module configured to generate at least one engagement value based on a calculated relationship between the first and second time-series and an adaptation module configured to receive the at least one engagement value and modify execution of computer executable instructions by a processor based on the received engagement value.

### CROSS-REFERENCE TO RELATED PATENT APPLICATIONS

This application claims the benefit of and priority to U.S. Provisional Application No. 61/895,906, filed on Oct. 25, 2013, the entire disclosure of which is incorporated by reference herein.

### FIELD OF THE INVENTION

The present disclosure relates generally to adaptation of software, and, more particularly, to adapting software to measured engagement in a subject.

### BACKGROUND

Users of software, multi-media games, audio/visual media, and educational software can experience lapses of engagement or immersion in the content presented by way of software, games, or media. These lapses can diminish the effectiveness of the content, or the media and software through which it is presented, for entertainment, analytic, and/or educational intents. Engagement can be associated with physiological, behavioral, or subjective attributes of a user or subject.

### SUMMARY

One aspect of the disclosure is directed to an engagement-adaptive system. The system includes a content delivery module configured to deliver content to a user, a context logger configured to associate events in the delivered content with temporal locations in a first time-series. The system also includes an indicator measurement module configured to measure at least one engagement indicator and associate the measurements with temporal locations in a second time-series. The system includes an engagement analysis module configured to generate at least one engagement value based on a calculated relationship between the first and second time-series and an adaptation module configured to receive the at least one engagement value and modify execution of computer executable instructions by a processor based on the received engagement value.

Another aspect of the disclosure is directed to a method for engagement-based adaptation. The method begins with delivering content to a user. The method further includes associating events in the delivered content with temporal locations in a first time-series, measuring at least one engagement indicator of the user, and associating the measurements of engagement indicators with temporal locations in a second time-series. The method also includes generating at least one engagement value based on a calculated relationship between the first and second time-series and modifying the execution of computer executable instructions based on the at least one engagement value.

Another aspect of the disclosure is directed to a computer readable media storing processor executable instructions which when carried out by one or more processors, cause the processors to receive at least one measurement of at least one engagement indicator of a user associated with the delivery of the content to the user. The instructions further cause the processors to associate events in the delivered content with temporal locations in a first time-series, associate the measurements of engagement indicators with temporal locations in a second time-series, and generate at least one engagement value based on a calculated relationship between the first and second time series. The calculated relationship between the first and second time-series is a dependency between first time-series and the second time-series, or the co-variation between the first time-series and the second time-series calculated by the function,

$$\frac{σ ( [ {V}_{indicator} ( t ) ] \cdot [ {V}_{context} ( t ) ] )}{σ ( [ {V}_{indicator} ( t ) ] )} ,$$

wherein V_{context}(t) is the first time-series and V_{indicator}(t) is the second time-series and σ is a variance function. The instructions further cause the processors to modify the execution of computer executable instructions based on the received engagement value.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a schematic diagram of an example system for engagement adaptation, according to an illustrative implementation;

FIG. 2 is a flow diagram of an example process carried out by an engagement-adaptive system;

FIG. 3 is a flow diagram of another example process carried out by an engagement-adaptive system;

FIG. 4 is a flow diagram of an example process carried out by an engagement-adaptive system for adaptation of educational content delivery;

FIG. 5 is a flow diagram of an example process carried out by an engagement-adaptive system for adaptation of a multi-media game;

FIG. 6 is a flow diagram of an example process carried out by an engagement-adaptive system for adaptation of audio/visual media;

### DETAILED DESCRIPTION

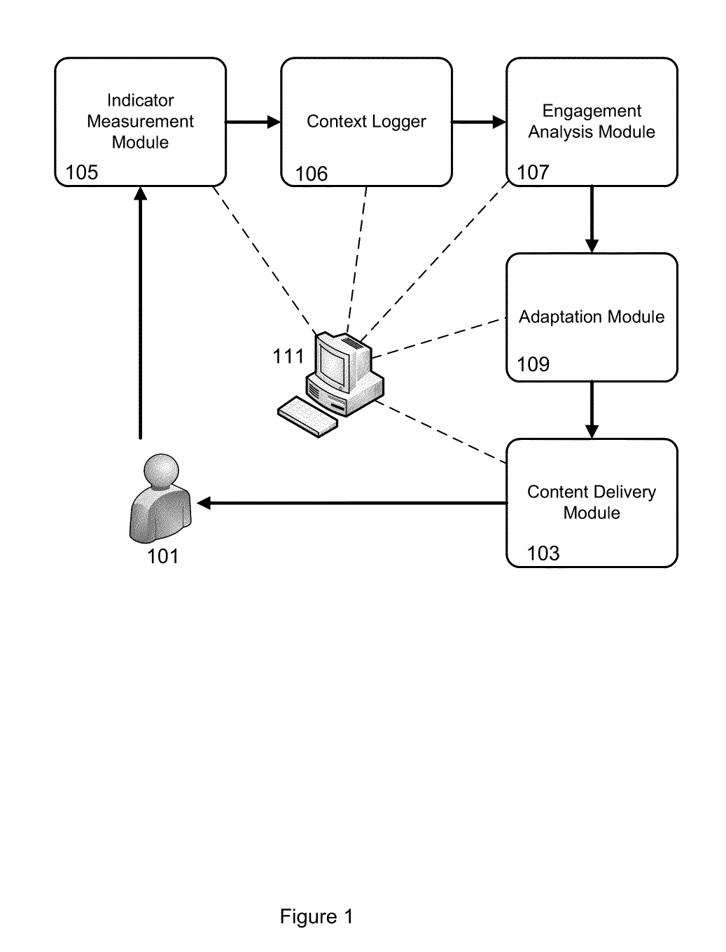

FIG. 1 is a schematic diagram depicting an engagement-adaptive system 100. In some implementations, the system 100 includes a content delivery module 103 configured to deliver content to a subject. The system 100 also includes an indicator measurement module 105, a context logger 106, an engagement analysis module 107, and an adaptation module 109. The modules included in the engagement-adaptive system 100 can be implemented on one or more computing devices. In some implementations, the system 100 is implemented on one computing device 111. In some other implementations, the system 100 can be implemented on more than one computing devices. For example the content delivery module 103 can be included on one computing device and the indicator measurement module 105, context logger 106, engagement analysis module 107, and adaptation module 109 can be distributed over multiple other computing devices.

The computing device 111 can be a personal computer, a mobile device, a distributed computing system, or a combination thereof. In some implementations the computing device includes memory, one or more processors and a display. In some implementations, only one or some of the computing devices that the system is implemented on include a display.

The content delivery module 103 is configured to deliver content to a subject 101. In some implementations, the content delivery module 103 delivers content via an audio speaker or via an electronic display. The content can be text, images, video, audio, or other multi-media content. In some implementations, the content includes one or more tasks or educational concepts presented to the subject 101. The content delivery module 103 can include a user interface through which the content is delivered or presented to the subject 101. In some implementations, the content delivery module 103 also includes a user interface that allows a user to select content to be delivered to a subject 101. The content delivery module can also deliver content that has been selected to be delivered to a subject 101 by the adaptations module 109. The adaptation module 109 is discussed in greater detail below.

In some implementations, goals or objectives are presented to the subject 101 via an interactive program included in the content delivery module 103. For example, goals or objectives can be presented to the subject 101 in a mission-based video game or interactive simulator. As a more specific example, a video game where the subject 101 directs a virtual character through a virtual map may include presenting a task to the subject 101 that prompts the subject 101 to direct the virtual character to a specific location on the virtual map.

In other implementations, the content delivery module 103 can include a user interface that interacts with the subject 101. For example, the user interface of the content delivery module 103 can include a human-like avatar that the subject 101 interacts with via speech, motion, text, or other controller. Additionally, the user interface can include a graphic user interface displaying and allowing the user to manipulate data, including but not limited time-series data, geo-spatial data, tabular data and others. The content delivery module 103 can include touch-screens, keyboard and mouse input devices, audio dictation, and other input devices to allow a user to interact with the user interface.

In other implementations, the content delivery module 103 can present audio/visual media or text to the subject 101. In some such implementations, the media or text presented to the subject 101 can be narrative. As an example, the content delivery module 103 can present a dramatic motion picture to the subject 101. Other examples of narrative media that can be presented to the subject 101 by the content delivery module 103 include audio delivered to the subject 101 or a story narrated through text displayed to the subject 101. In some implementations, the media delivered to the subject 101 by the content delivery module 103 is not narrative. For example, the content delivery module 103 can display abstract paintings to the subject 101.

In some implementations, the content delivery module 103 can return feedback or results of a query to the subject 101. For example, the user interface of the content delivery module 103 can include a search engine that allows the subject 101 to search a database or the internet and in response return results of the search to the subject 101.

In some other implementations, the content can include one or more training exercises designed to educate the subject 101 on one or more topics, or train them in one or more skills. The one or more training exercises can be presented to the subject 101 via an interactive program included in the content delivery module 103. For example, the user interface of the content delivery module 103 can include an interactive math teaching program that presents arithmetic training exercises to the subject 101.

In some implementations, the content delivery module 103 presents educational media including audio/visual media or text to the subject 101. The educational media can include teaching moments or pedagogical events. As an example, the user interface of the content delivery module 103 can present a video lecture that includes informational slides to the subject 101. Additionally, the user interface of the content delivery module 103 can present an audio dictation of a book, such as a text book or reference volume.

The system 100 also includes a context logger 106 configured to temporally map events associated with delivery of content by the content delivery module 103 to a context timeline. Events, features or occurrences during the delivery of content to the subject 101 associated with, or mapped to, temporal locations in a time-series is referred to herein as “context.” Events associated with content can include, but are not limited to, goals or objectives implicitly or explicitly given or presented to a subject 101, narrative elements or plot points in audio/visual media, feedback to subjects, teaching moments or pedagogical events, software prompts, the activities of a subject 101, or conversational elements. In some implementations, events can be categorized by the context logger 106. For example, narrative elements and subject activities can be different categories of events associated with the same content delivered to a subject 101. Event categories may be specified a priori or post hoc of the delivery of content to the subject 101. Event categories may be hierarchically organized. As examples, goals can be nested within larger goals, or conversational elements can be nested within topics. The context logger 106 may also provide labels for events. Event labels may be used for categorizing them by some user-defined scheme. The context logger may include a user interface for a user to input event labels or categorize events following presentation or prior to presentation to the subject 101. In some implementations, the context logger 106 can also log features of the content delivered to the subject 101 as events. As an example, features might refer to appearances of a certain persons, places, or things in video media or interactive games, specific acts or behaviors of persons and things (e.g., facial expressions), and or interactions (e.g., conversations). Other examples of how features might be categories might include depictions of violence in video media or interactive games, presented in different situations, for example, political violence, cartoon violence, inter-group, or intra-group violence.

As an example, the content delivery module can include a display that presents a narrative motion picture to a subject 101. Events associated with the display of a narrative motion picture to a subject 101 can include plot points such as the death of a character, narrative elements such as an explosion, or other events in the motion picture such as the display of a blank screen or a loud sound.

As another example, events associated with the delivery of educational media to a subject 101 can include teaching moments, the presentation of a concept, or the delivery of a task to the subject 101. More specifically, the content delivery module 103 can include an interactive math training program that presents lectures to the subject 101 and presents arithmetic practice problems to the subject 101 after the lecture. The explanation of a rule to the subject 101, the presentations of tasks such as presenting practice problems to the subject 101, and the subject 101 responding to the practice problems can be events in this example.

The context logger 106 maps events in the content delivered to the subject 101 by the content delivery module 103. As mentioned above, events may be categorized by type of event. In some implementations, event categories are user defined. In other implementations, event categories are determined by the context logger 106. The context logger 106 can map multiple categories of events to the same context timeline. In some implementations, multiple categories of events can be mapped to different context timelines. For example, subject activity events and teaching moment events can be mapped to different context timelines.

In some implementations, the context logger 106 can generate a context timeline as a random variable or conceptual vector using Equation 1 below.

V_{context(j)}(t) (1)

In Equation 1, V is a vector of 1 and 0's expressing the presence (1) or absence (0) of a context event of category j, in sequence across the time-series (t), where t represents the number of time windows used to segment the total time the context is presented to the subject 101. Both V and t are vectors of the same length N, expressible as either row or column vectors, where N is equal to some pre-specified number of segments. For example, V_{context(j)}(t)=[0 1 0 1 11 0 1].

In some implementations, the context logger 106 includes a user interface that allows a user to input or select events in the content and select or input time points for events. In some implementations, the context logger 106 can detect events and time points automatically.

The system 100 includes an indicator measurement module 105 configured to measure engagement indicators from the subject 101. The indicator measurement module 105 can store measured indicators as subject data. Subject data includes behavioral, signal, or subject response data that describe what the subject 101 did or how they reacted and temporal locations for each such datum. The indicator measurement module 105 maps subject data to a subject data timeline. Indicators are measured from the subject 101 as the content delivery module 103 delivers content to the subject 101. In some implementations, indicator measurements are mapped to subject data timelines by a user through a user interface included in the indicator measurement module. In some implementations, indicator measurements are automatically mapped to a subject data timeline by the indicator measurement module 105.

Engagement indicators can include physiological or measurements of the subject 101, success or failure performance outcomes of specific tasks, categorical data (i.e., selections among finite categories), “Likert” Scale responses (10 point scales), choices made in response to stimuli, eye-tracking data, behavioral response frequencies, behavioral reaction times, counts of postural changes, sensor data describing movement along any number of axes (i.e., weight distribution), accelerometry data, electroencephalography (EEG) data facial affect (i.e., counts of facio-muscular pattern shifts), or other physiological or psychological indicators of attention. In some implementations, the indicator measurement module 105 receives measurements from physiological, neurophysiological, or other sensors that provide quantitative measurements of subject features. For example, the indicator measurement module 105 can receive subject pulse data through a pulse oximeter, or respiration data from a capnometer. The indicator measurement module 105 can also receive indicator data, such as subject responses or success or failure indicators, from the content delivery module 103. In some implementations, the indicator measurement module 105 includes a user interface that allows a user to input indicator data such as behavioral observations of the subject 101.

Engagement indicator measurements can be categorized by the indicator measurement module 105 automatically or may be categorized by a user through a user interface included in the indicator measurement module 105. Engagement indicator measurements can be categorized into any of a variety of user inputted categories. For example, categories of engagement indicator measurements can include nominal data such as success or failure indicators, categorical data such as the subject's 101 choice of a value or Likert scale responses, physiological data such as temperature or electrodermal response data, behavioral data, eye-tracking data, or other categories of indicators. The indicator measurement module 105 can map multiple categories of engagement indicator measurements to the same subject data time-series, or subject data timeline. In some implementations, multiple categories of engagement indicator measurements can be mapped to different subject data timelines. For example, nominal data and behavioral data can be mapped to different subject data timelines.

The indicator measurement module 105 can generate a context timeline as a random variable or conceptual vector using Equation 2 below.

V_{indicator}(i)(t) (2)

In Equation 2, V is a vector of numbers expressing subject data of category i, sampled in sequence across the time-series (t), where t represents the number of time windows used to segment the total time the context is presented to the subject. Both V and t are vectors of the same length N, expressible as either row or column vectors, where N is equal to some pre-specified number of segments. For example, a subject data timeline for nominal data can be expressed as V_{indicator}(i)=[1 0 1 1 1 1 0 1] (Nominal Data) and a subject data timeline for categorical data can be expressed as V_{feature}(i)(t)=[1 2 4 5 2 1 2 3] (Categorical Data).

The system 100 also includes an engagement analysis module 107 configured to calculate an engagement value for the subject 101 based on subject data and context data. The engagement analysis module 107 generates an engagement value that is the proportion of variance in subject data timelines for a given feature or fusion of features, that is accounted for by context. In some implementations, subject data may be fused by one of a variety of mathematical operations that result in one or more fused subject data vectors or values. As one example, a nominal subject data vector can be multiplied by a categorical subject data vector to generate a fused subject data vector. The subject data can be correlated with context data by one of many suitable mathematical operations to generate an engagement value or an engagement vector that includes an engagement value for multiple time points in a timeline. Engagement values can also be expressed for each event in the context. For example, the engagement analysis module 107 can generate an engagement value by using Equation 3 below.

$$\frac{σ ( [ {V}_{indicator ( i )} ( t ) ] \cdot [ {V}_{context ( j )} ( t ) ] )}{σ ( [ {V}_{indicator ( i )} ( t ) ] )} \qquad ( 3 )$$

In Equation 3, the numerator is the variance (σ) of the intersection, interaction, or convolution, of the subject data and context data. The denominator is the variance (σ) of subject data. The variance of subject data may be expressed as variance around a subject's mean measured indicator value, group of subjects' mean indicator data, and/or probabilities of subject responses. This results in a ratio, coefficient, percentage, or proportion of variance in subjects' data that is attributable to the context they are presented to, which reflects how engaged a subject is within the specific context presented to them. This conceptual equation may be expressed in a variety of statistical or mathematical models, including but not limited to, regression, correlation, mutual information, and spectral analysis.

In some other implementations, the subject data vector in the denominator can be built from other data from the subject. For example, a random sample of subject data from the subject, independent of the context can be used to generate the denominator.

The engagement analysis module 107 carries out the calculations described above to generate engagement values. The engagement analysis module 107 can also store engagement values in the memory of a computing system for use by the adaptation module 109 or for other uses.

In some implementations, the engagement analysis module 107 generates engagement values within the same context, estimating the degree of coherence between a subject 101 and a given context, inferred from the proportion of variance in an indicator describing the subject's engagement with events in the content (i.e., behavior, physiology, etc.). The engagement analysis module 107 can generate engagement values by using Equation 3 or other techniques of measuring co-variation or dependency between context data and subject data. Equation 3 is amenable to most statistical tests of magnitude such that the output engagement value constitutes a coefficient of variance components that may be subjected to significance testing. For example, in a general linear model implementation, to test the significance of engagement within a given subject 101, the subjects' own time-series data should be treated as an independent sample. The numerator of Equation 3, may be called an independent variable representing the cross-product of indicators, which may then be correlated with or regressed against the denominator of Equation 3, or the dependent variable, representing the total variance in indicator measurements and context. This results in a correlation or regression coefficient that can be tested for magnitude using standard normal frequency distributions and derived “ranges of rejection”. Engagement within specific events are also directly comparable by a statistical test in differences between two coefficients, or within the same multivariate model including terms representing the cross-product of indicator measurements with two different context vectors, representing different categories of contextual events. In some implementations, the engagement analysis module 107 can use Equation 3 to test whether engagement is different from “noise”, but utilizing a completely random vector (or “noise vector”) and comparing the resulting coefficients.

In other implementations, the engagement analysis module 107 can generate between-subject engagement values, where it may be of interest whether numerous subjects, or subsets of subjects were engaged in the same or similar context. Using either aggregated or fused subject data of multiple subjects or hierarchical modeling procedures, multi-subject sample engagement may be calculated and subjected to significance testing, and both sub-samples' overall engagement in context or using best-practices in standard multivariate or moderation analysis.

In some implementations, the engagement analysis module 107 generates between-context engagement values by examining engagement between different contexts. This may constitute a comparison between the same or different subjects interacting with substantively different or incrementally different user interfaces (e.g., different software packages), multi-media (e.g., interactive games vs. non-interactive videos), different platforms (e.g., touch screen vs. keyboard interfaces; Personal computer vs. hand-held/smart phone interfaces), and others comparisons. In some such implementations, two or more different contexts may be similarly logged, or identified such that the same contextual events, or categories and classes thereof, may be sampled from the two different contexts. Context vectors for each different context may be fused and weighted to normalize the relative number of events sampled from each context. Subjects' overall engagement to the context, or to categories of contextual events are calculated by the engagement analysis module 107 for each of the two or more contexts, using Equation 3 or other mathematical operations, such as general linear modeling. The engagement values can be compared by the engagement analysis module 107 by using best statistical practices. In other implementations, two or more different contexts may be identified. Context vectors for each different context may be fused and weighted to normalize the relative number of events sampled from each context. Subjects' overall engagement to the context can be generated using Equation 3 or other mathematical operations, such as general linear modeling, and compared using best statistical practices.

The adaptation module 109 included in the system 100 is configured to select content based on engagement values generated by the engagement analysis module 107. In some implementations, the adaptation module uses engagement values stored in a memory to select content that is associated with higher engagement values to be delivered to the subject 101 by the content delivery module 103. The adaptation module 109 can also select content that has not been previously delivered to the subject 101 but has been associated with higher or lower engagement values in other subjects. In some implementations, the adaptation module 109 selects different content than has been previously delivered to the subject 101. In some other implementations, the adaptation module 109 selects modified versions of content that has previously been delivered to the subject 101. The modified versions of content can include different features than the unmodified content and can be selected based on higher or lower engagement values associated with the specific features.

The adaptation module 109 can also select content based on ranges of engagement values or threshold engagement values. In some implementations, the adaptation module generates profiles of subjects based on engagement values resulting from the delivery of specific content to the subjects. In such implementations, the adaptation module 109 can select content to be delivered to the subject 101 based on the generated profile. The adaptation module 109 can also categorize content based on engagement values associated with specific content. Subject profiles generated by the adaptation module 109 can include categories of content that were associated with specific engagement values or ranges of engagement values.

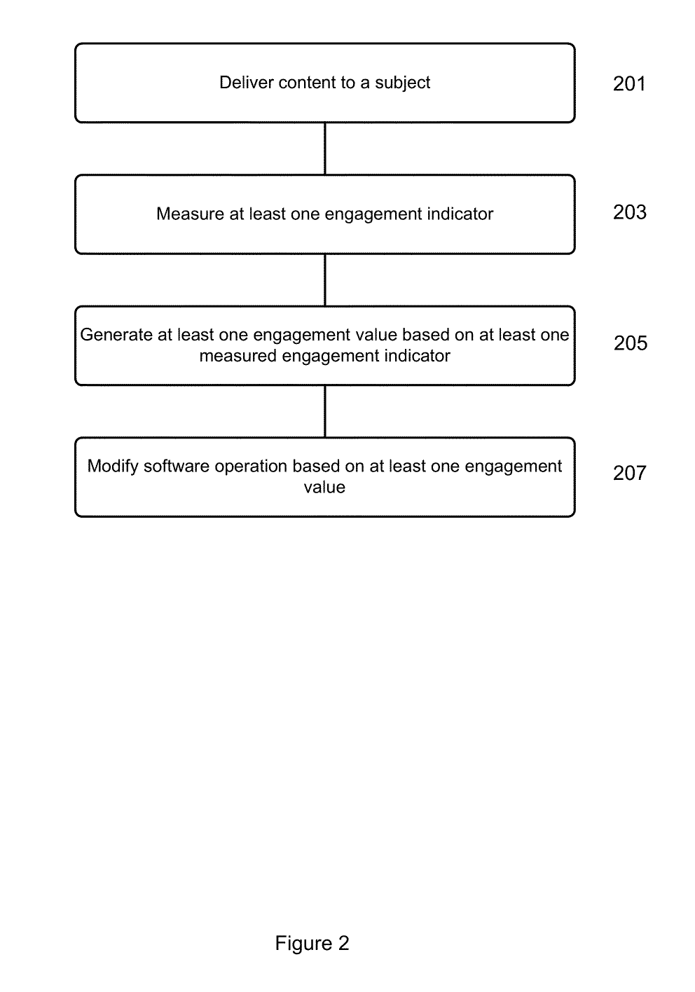

FIG. 2 is a flow chart depicting a process that can be carried out by the engagement-adaptive system 100. The process begins with the content delivery module 103 delivering content to a subject 101 (step 201). The indicator measurement module 105 then measures at least one engagement indicator (step 203). Based on the one or more measured engagement indicators, the engagement analysis module 107 generates at least one engagement value (step 205). The adaptation module 109 modifies the operation of the software that is included in the system 100 based on the one or more engagement values (step 207).

The content delivery module 103 delivers content to a subject 101 by one or more of any suitable methods. In some implementations, delivering content to a subject 101 can include presenting audio/visual media to the subject 101 via a display, speakers, headphones or any other suitable method. As described above, content delivered by the content delivery module 103 to the subject 101 can include text, images, video, audio, other multi-media content, tasks, goals, educational material, or other content. The content can be delivered to the subject 101 via a user interface that is included in the content delivery module 103. In some implementations, the content delivery module 103 includes an interactive program that that the subject interacts with via a user interface.

The indicator measurement module 105 measures at least one engagement indicator from the subject 101 (step 203). Engagement indicators can include physiological measurements of the subject 101, success or failure performance outcomes of specific tasks, categorical data (i.e., selections among finite categories), “Likert” Scale responses (10 point scales), choices made in response to stimuli, eye-tracking data, behavioral response frequencies, behavioral reaction times, counts of postural changes, sensor data describing movement along any number of axes (i.e., weight distribution), accelerometry data, electroencephalography data, facial affect (i.e., counts of facio-muscular pattern shifts), or other physiological or psychological indicators of attention.

The indicator measurement module 105 can receive data from sensors, diagnostic devices, probes, cameras, microphones or other hardware configured to detect attributes of the subject. The indicator measurement module 105 stores quantitative measurements of indicators in a memory or database associated with the engagement-adaptive system 100. The indicator measurement module 105 correlates measurements of engagement indicators with a subject data timeline that indicates temporal location of the measurement. Engagement indicator measurements associated with a timeline are referred to as subject data. As described above, subject data can be expressed by the indicator measurement module 105 as one or more vectors. The indicator measurement module 105 can use Equation 2, above, to express subject data. In some implementations, the indicator measurement module 105 categorizes engagement indicator measurements. The indicator measurement module 105 can generate subject data for individual categories of indicator measurements or it can combine one or more categories of individual indicator measurements in the same subject data timeline.

Based on the measured engagement indicators, the engagement analysis module 107 generates one or more engagement values (step 205). The engagement analysis module 107 correlates subject data generated by the indicator engagement module 105 and context data generated by the context logger 106 to generate one or more engagement values. In some implementations, the engagement analysis module 107 expresses engagement values as vectors that associate individual engagement values with temporal location. In some other implementations, the engagement analysis module 107 generates engagement values for events within specific content or broader content categories.

As described above, the engagement analysis module 107 can use Equation 3 to generate engagement values. The engagement analysis module 107 can generate independent engagement values for categories of subject data or, in some implementations, can fuse engagement values by performing mathematical operations on subject data vectors. For example, a behavioral response subject data vector can be multiplied by, added to, or averaged with a categorical subject data vector to generate a fused subject data vector. Additionally, two or more channels of physiological data, for example, eye-tracking and electromyography data, can be fused into one subject data vector.

The adaptation module 109 modifies the operation of software included in the system 100 based on the engagement values generated by the engagement analysis module 107. In some implementations, modifying the operation of software includes selecting content to be delivered to the subject 101 via the content delivery module 103. In some other implementations, the adaptation module 103 can modify the operation of software included in the engagement-adaptive system 100 to repeat the delivery of certain content based on the engagement values generated by the engagement analysis module 107. In yet other implementations, the adaptation module can modify a user interface based on engagement values. For example, in response to low engagement values generated by the engagement analysis module 107 when certain text is presented to a subject via the content deliver module 103, the adaptation module 109 can increase the size of text displayed to the subject or apply a speech to text module that reproduces the text in auditory fashion. The adaptation module 107 can select content delivery modalities (output to user) such as text display, video, audio, other visual display, motion or haptic response, gesture interaction or other content delivery modalities based on engagement values associated with modalities. The adaptation module 107 can also select or alter the modalities with which users or subjects can interact or control the content. In some implementations, the adaptation module 107 can change or select a different input device based on engagement values. For example, the adaptation module 107 can move certain functionality of the interface, previously mapped to a joystick, to an audio microphone. As another example, the adaptation module 107 can automate certain repeated behaviors users or subjects reliably evince in interacting with the content. The adaptations module 107 can also dynamically change the configuration of the input device (e.g., “key mapping” on a key board, or other controller), or divert a subset of functions to a secondary input device (e.g., mobile device).

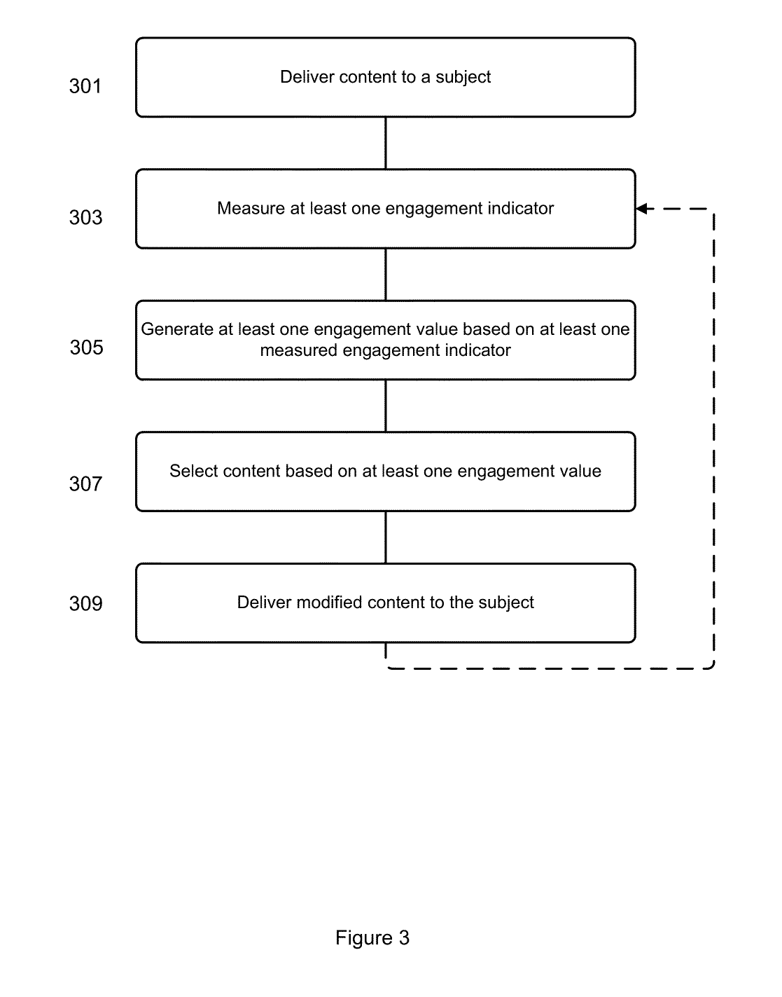

FIG. 3 is a flow chart depicting a process that can be carried out by the engagement-adaptive system 100. The process begins with the content delivery module 103 delivering content to a subject 101 (step 301). The indicator measurement module 105 then measures at least one engagement indicator (step 303). Based on the one or more measured engagement indicators, the engagement analysis module 107 generates at least one engagement value (step 305). The adaptation module 109 selects content to be delivered to the subject based on the one or more engagement values (step 307). The content delivery module 103 then delivers the selected content to the subject (step 309). In some implementations, the indicator measurement module 105 again measures engagement indicators from the subject so the system 100 can again generate engagement values.

The content delivery module 103 delivers content to a subject 101 by one or more of any suitable methods (step 301). In some implementations, delivering content to a subject 101 can include presenting audio/visual media to the subject 101 via a display, speakers, headphones or any other suitable method. As described above, content delivered by the content delivery module 103 to the subject 101 can include text, images, video, audio, other multi-media content, tasks, goals, educational material, or other content. The content can be delivered to the subject 101 via a user interface that is included in the content delivery module 103. In some implementations, the content delivery module 103 includes an interactive program that that the subject interacts with via a user interface.

The indicator measurement module 105 measures at least one engagement indicator from the subject 101 (step 303). Engagement indicators can include physiological measurements of the subject 101, success or failure performance outcomes of specific tasks, categorical data (i.e., selections among finite categories), “Likert” Scale responses (10 point scales), choices made in response to stimuli, eye-tracking data, behavioral response frequencies, behavioral reaction times, counts of postural changes, sensor data describing movement along any number of axes (i.e., weight distribution), accelerometry data, electroencephalography data, facial affect (i.e., counts of facio-muscular pattern shifts), or other physiological or psychological indicators of attention.

The indicator measurement module 105 can receive data from sensors, diagnostic devices, probes, cameras, microphones or other hardware configured to detect attributes of the subject. The indicator measurement module 105 stores quantitative measurements of indicators in a memory or database associated with the engagement-adaptive system 100. The indicator measurement module 105 correlates measurements of engagement indicators with a subject data timeline that indicates temporal location of the measurement. Engagement indicator measurements associated with a timeline are referred to as subject data. As described above, subject data can be expressed by the indicator measurement module 105 as one or more vectors. The indicator measurement module 105 can use Equation 2, above, to express subject data. In some implementations, the indicator measurement module 105 categorizes engagement indicator measurements. The indicator measurement module 105 can generate subject data for individual categories of indicator measurements or it can combine one or more categories of individual indicator measurements in the same subject data timeline.

Based on the measured engagement indicators, the engagement analysis module 107 generates one or more engagement values (step 305). The engagement analysis module 107 correlates subject data generated by the indicator engagement module 105 and context data generated by the context logger 106 to generate one or more engagement values. In some implementations, the engagement analysis module 107 expresses engagement values as vectors that associate individual engagement values with temporal location. In some other implementations, the engagement analysis module 107 generates engagement values for events within specific content or broader content categories.

As described above, the engagement analysis module 107 can use Equation 3 to generate engagement values. The engagement analysis module 107 can generate independent engagement values for categories of subject data or, in some implementations, can fuse engagement values by performing mathematical operations on subject data vectors. For example, a behavioral response subject data vector can be multiplied by, added to, or averaged with a categorical subject data vector to generate a fused subject data vector.

The adaptation module 109 selects content to be delivered to the subject 101 based on the engagement values generated by the engagement analysis module 107 (step 307). In some implementations, the adaptations module 109 selects content from a database or memory. In some implementations, the adaptation module 109 can select content that has previously been delivered to the subject 101 to repeat the delivery of certain content based on the engagement values generated by the engagement analysis module 107. The adaptation module 109 can also categorize content based on engagement values associated with the content. In some implementations, the adaptation module 109 selects content belonging to categories based on engagement values or ranges of engagement values. In some implementations, the adaptation module can select a modality of content delivery. For example, the adaptation module can include a text-to-speech engine that generates audio content from text to be delivered to the subject 101 or a speech-to-text engine that converts spoken content to text for a subject 101 to read.

The content delivery module 103 delivers the content selected by the adaptation module 109 to the subject 101 (step 309). In some implementations, the indicator measurement module 105 measures at least one engagement indicator from the subject 101 (step 303) during the delivery of the selected content.

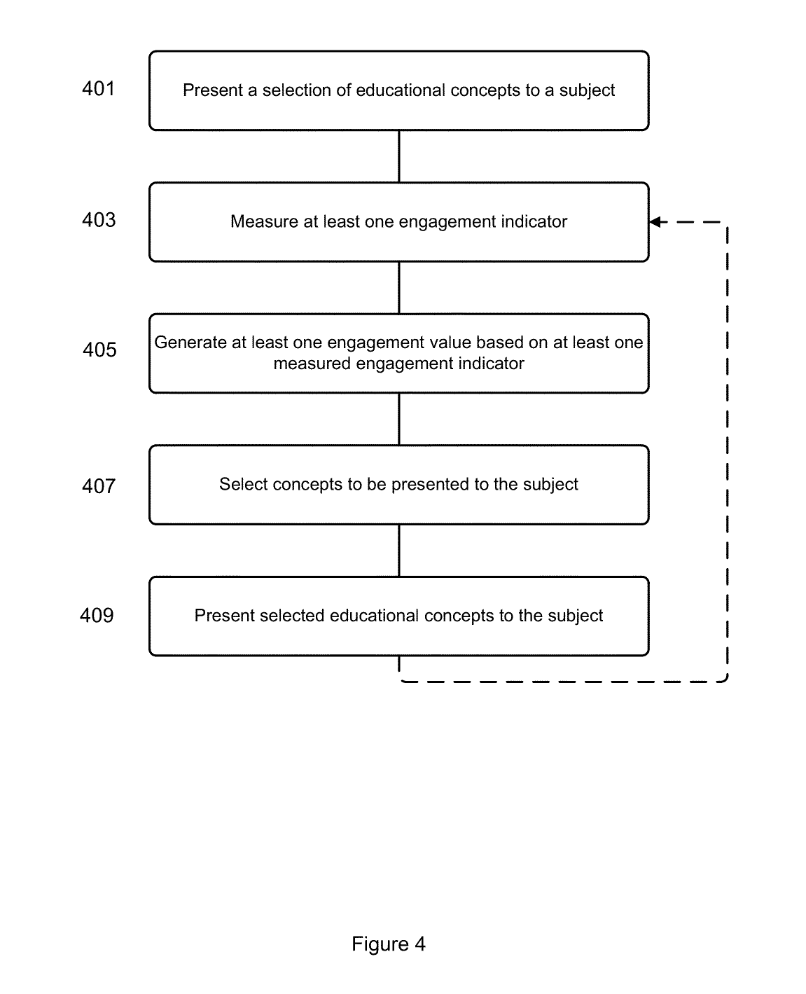

FIG. 4 is a flow chart of a process that can be carried out by the engagement-adaptive system 100 to adapt an educational system based on subject engagement. The process begins with the content delivery module 103 presenting educational concepts to a subject 101 (step 401). The indicator measurement module 105 measures engagement indicators from the subject 101 (step 403). The engagement analysis module 107 generates at least one engagement value based on the one or more measured engagement indicators (step 405). The adaptation module 109 selects concepts to be presented to the subject 101 based on the generated engagement values (step 407) and the content delivery module 103 delivers the selected concepts to the subject (step 409). In some implementations, the indicator measurement module 105 again measures engagement indicators from the subject 101.

The content delivery module 103 can present educational concepts to a subject 101 (step 401) in any of a variety of modalities. The educational concepts can be presented as audio or video lectures, slide shows, text display, interactive programs, tasks, any other suitable mode of presenting educational material, or a combination thereof. For example, the delivery of content to the subject 101 can include displaying slides to a subject while playing an audio lecture followed by an interactive program that requires the subject to input responses to practice questions. In some implementations, the content can be grouped by concept. For example, one session can include a slide show and audio lecture on one concept and another session can follow that includes a slide show and audio lecture on a different concept.

The context logger 106 maps events in the content to a context timeline as described above in reference to FIG. 1. Events in educational content can include the presentation of specific concepts, the delivery of tasks, or the subject 101 inputting a response into a user interface. For example, the user inputting responses to practice questions can be an event. Events can be different lengths of time. For example, the presentation of each slide in a slide show can be an event or, in other implementations, a group of slides or a slide show as a whole can be an event. In some implementations, an educational session focused on one major concept can be used as an event by the context logger 106. For example, the content delivery module can present a series of sessions that each include an audio lecture accompanied by slides as well as a set of practice problems and each session can be considered a single event by the context logger 106. The context logger 106 can also use modalities of content delivery as events. For example, a concept can be presented to a subject 101 as a visual slide show, as an audio lecture, or in text displayed on an electronic display. The context logger 106 can log the different modalities (slide show, audio, text, etc.) as events so the engagement analysis module 107 can generate engagement values associated with the different modalities.

The indicator measurement module 105 measures engagement indicators from the subject 101 (step 403). The indicator measurement module 105 can receive data form any of a variety of sensors, probes or cameras. For example, the indicator measurement module 105 can receive eye-tracking data from a camera while the subject 101 is viewing a slide show. As another example, the indicator measurement module 105 can receive electrodermal data of the subject 101 from a skin conductance sensor associated with the indicator measurement module 105. As described above, the indicator measurement module 105 generates subject data that includes measurements of engagement indicators as well as temporal locations associated with the measurements. In some implementations, the indicator measurement module 105 generates subject data vectors as described above and using Equation 2. The indicator measurement module 105 can store subject data in a database or memory associated with the system 100.

The engagement analysis module 107 generates one or more engagement values based on the one or more measured engagement indicators (step 505). As described above in reference to FIGS. 2 and 3, the engagement analysis module 107 correlates or ascertains the probabilistic dependency between context data and subject data to generate engagement values that can be expressed as vectors or can be individual engagement values associated with specific events.

The adaptation module 109 selects educational concepts to be delivered to the subject 101 (step 407). In some implementations, the adaptation module 109 selects educational content based on engagement values associated with different concepts included in the content. For example, if a certain slide in a slide show is associated with a lower engagement value, that slide or content within that slide can be selected by the adaptation module 109 to be repeated. As another example, if a certain type of practice problem is associated with higher engagement values for a given subject 101, the adaptation module 109 can select additional practice problems of that type to be delivered to the subject 101. The adaptation module can select a modality for the presentation of concepts based on engagement values associated with different modalities. For example, if audio lectures result in higher engagement values than text display for a subject, the adaptation module 109 can select audio as a preferred modality for the delivery of content or visa versa.

The content delivery module 103 delivers the content selected by the adaptation module 109 (step 409) and the indicator measurement module 105 can measure engagement indicators during the delivery of the selected content. In some implementations, the process goes through many iterations or is continuous, so the content is continually adapting to the subject's 101 engagement. For example, the method can go through many iterations until threshold engagement values have been achieved for a variety of concepts for a given subject 101. In such implementations, a user interface for inputting such threshold values can be included in the adaptation module 109. In the event that the threshold engagement values are achieved, the adaptation module 109 can select no additional content to be delivered to the subject 101 or can select a completion message to be delivered to the subject 101.

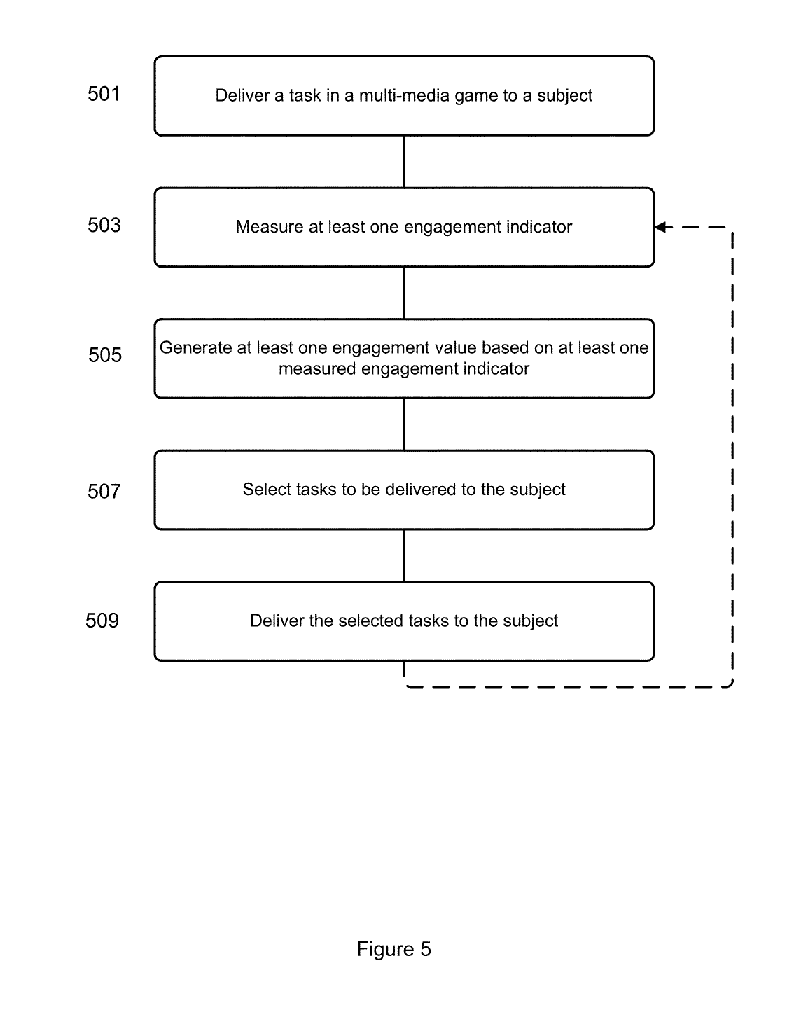

FIG. 5 is a flow chart of a process that can be carried out by the engagement-adaptive system 100 to adapt a multi-media game based on subject engagement. The process begins with the content delivery module 103 delivering tasks to a subject 101 (step 501) in a multi-media game. The indicator measurement module 105 measures engagement indicators from the subject 101 (step 503). The engagement analysis module 107 generates at least one engagement value based on the one or more measured engagement indicators (step 505). The adaptation module 109 selects tasks to be presented to the subject 101 based on the generated engagement values (step 507) and the content delivery module 103 delivers the selected tasks to the subject (step 509). In some implementations, the indicator measurement module 105 again measures engagement indicators from the subject 101.

The content delivery module 103 can deliver tasks to a subject 101 (step 501) via a user interface included in the content delivery module 103. The user interface included in the content delivery module 103 allows the subject to interact with a multi-media game. In some implementations, the game includes components that are stored in a memory or database and may be distributed across multiple computing systems. The user interface of the game is included in the content delivery module 103 and can deliver audio/visual stimuli or cues to the subject. The user interface can deliver tasks to the subject as part of the game. In some implementations, the game is included in the content delivery module in entirety. In some implementations, the game is a mission-based game, where the subject is given a series of tasks to be carried out by the subject within the game by interacting with media or prompts included in the content delivered via the user interface. The subject can interact with the media or prompts by inputting responses, clicking on objects within the game, directing a character in the game, or any other mode of gameplay. The user interface presents tasks to the subject as part of the game. For example, the user interface included in the content delivery module 103 can prompt a subject to navigate a virtual character in the game to a specific location on a virtual map displayed to the subject via the user interface. As another example, the user interface can direct the subject 101 to find a specific virtual object in a virtual landscape within the game. The user interface can also present the task of the subject 101 achieving a given number of points within the game. The user interface can present tasks to a subject via multiple different modalities. For example, the user interface may present the task to the subject 101 visually by displaying a goal that the subject 101 must accomplish for the task or the user interface can display text that describes the task to the subject 101.

The context logger 106 maps events in the game content to a context timeline as described above in reference to FIG. 1. Events in multi-media games can include the presentation of specific tasks, the display of visual media, the playing of audio, or instances of the subject 101 interacting with the game via the user interface. For example, the user interface prompting a subject to navigate a virtual character in the game to a specific location on a virtual map displayed to the subject via the user interface can be the delivery of a task and be logged by the context logger 106 as an event. The context logger can also log the delivery of tasks to a subject 101 by different modalities.

The indicator measurement module 105 measures engagement indicators from the subject 101 (step 503). The indicator measurement module 105 can receive data form any of a variety of sensors, probes or cameras. For example, the indicator measurement module 105 can receive eye-tracking data from a camera while the subject 101 is interacting with the game. As another example, the subject's response time to a certain task in the game can be measured by the indicator measurement module 107. As described above, the indicator measurement module 105 generates subject data that includes measurements of engagement indicators as well as temporal locations associated with the measurements. In some implementations, the indicator measurement module 105 generates subject data vectors as described above and using Equation 2. The indicator measurement module 105 can store subject data in a database or memory associated with the system 100.

The engagement analysis module 107 generates one or more engagement values based on the one or more measured engagement indicators (step 505). As described above in reference to FIGS. 2 and 3, the engagement analysis module 107 correlates or ascertains the probabilistic dependency between context data and subject data to generate engagement values that can be expressed as vectors or can be individual engagement values associated with specific tasks. In some implementations, engagement values associated with different tasks can be generated based on subject data associated with user responses. For example, a navigation task can have an engagement value associated which is based on subject data for the time period when the subject was inputting responses or navigating the virtual map. The engagement value associated with a specific event is not always based on subject data that is temporally aligned with that specific event, but rather can be based on other subject data.

The adaptation module 109 selects tasks to be delivered to the subject 101 (step 507) based on engagement values associated with different tasks or events. In some implementations, the adaptation module 109 selects a category of tasks based on engagement values. For example, if a certain type of task in the game, such as a navigation task, is associated with a greater engagement value, that type of task can be selected by the adaptation module 109 to be repeated. The adaptation module 109 can also select modalities of task delivery used by the user interface based on higher engagement values associated with that modality of task delivery.

The content delivery module 103 delivers the tasks selected by the adaptation module 109 (step 509) and the indicator measurement module 105 can measure engagement indicators during the delivery of the selected tasks. In some implementations, the process goes through many iterations or is continuous, so the content is continually adapting to the subject's 101 engagement.

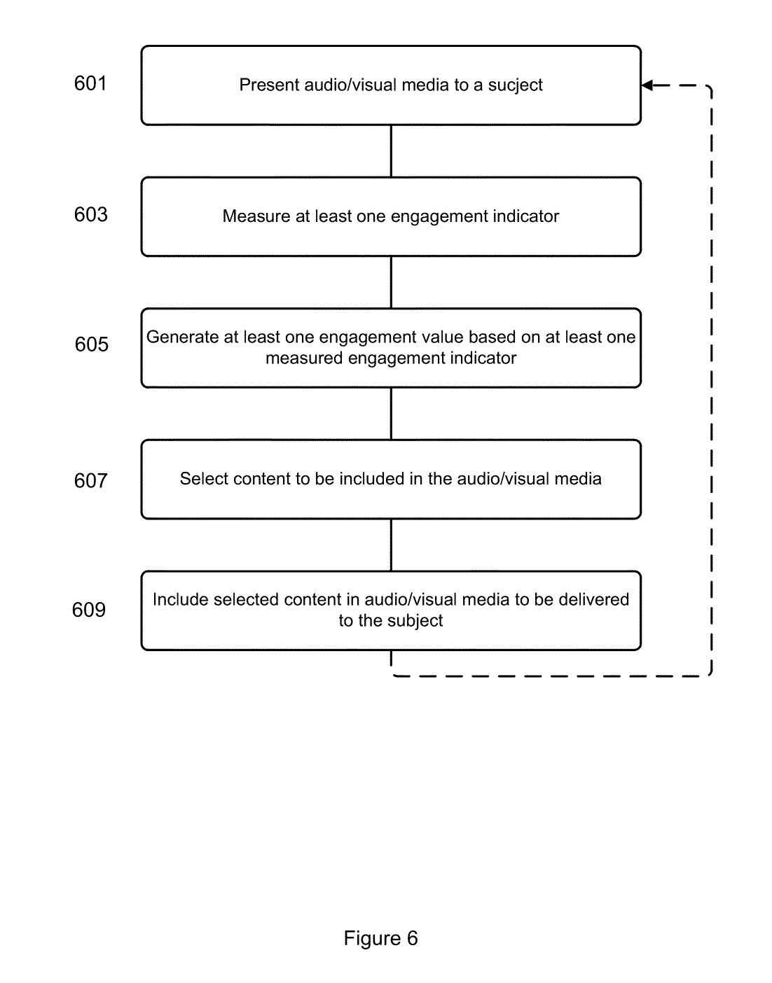

FIG. 6 is a flow chart of a process that can be carried out by the engagement-adaptive system 100 to adapt audio/visual media based on subject engagement. The process begins with the content delivery module 103 presenting audio/visual media to a subject 101 (step 601). The indicator measurement module 105 measures engagement indicators from the subject 101 (step 603). The engagement analysis module 107 generates at least one engagement value based on the one or more measured engagement indicators (step 605). The adaptation module 109 selects content to be presented to the subject 101 based on the generated engagement values (step 607) and the content delivery module 103 delivers the selected content to the subject 101 (step 609). In some implementations, the indicator measurement module 105 again measures engagement indicators from the subject 101.

The content delivery module 103 can present audio/visual media to a subject 101 (step 601) via a user interface, display, speakers, or any other suitable mode of delivering audio/visual media. The audio/visual media can be a motion picture, narrative audio work, photography, visual or audio art work, music, or any other audio/visual media. For example, the content delivery module 103 can display a narrative motion picture to the subject 101 via an electronic display. As another example, the content delivery module 103 can play an audio narrative for the subject 101 via speakers or headphones. In some implementations, the media is retrieved by the content delivery module 103 from a memory or database and delivered to the subject.

The context logger 106 maps events in the media to a context timeline as described above in reference to FIG. 1. Events in audio/visual media can include the appearance of a visual feature, color or character, a narrative element or plot element, a specific sounds, change in display attribute, change in audio quality, or a visual or auditory cue. For example, in a narrative motion picture displayed to the subject, explosions or car-chase scenes are events. As another example, a crescendo is an event in a piece of music that is played to the subject via speakers. The context logger 106 can also log modalities of media delivered to the subject 101. In some implementations, the context logger 106 can also log genres of media delivered to the subject 101. For example, the context logger 106 can log mystery narratives or comedy narratives as events so the engagement analysis module 107 can generate engagement values associated with those genres.

The indicator measurement module 105 measures engagement indicators from the subject 101 (step 603). The indicator measurement module 105 can receive data form any of a variety of sensors, probes, motion capture devices, or cameras. For example, the indicator measurement module 105 can receive eye-tracking data from a camera while the subject 101 is watching visual media. As another example, the indicator measurement module 105 can receive electroencephalography (EEG) data from an EEG probe while the subject 101 is listening to audio media. As described above, the indicator measurement module 105 generates subject data that includes measurements of engagement indicators as well as temporal locations associated with the measurements. In some implementations, the indicator measurement module 105 generates subject data vectors as described above and using Equation 2. The indicator measurement module 105 can store subject data in a database or memory associated with the system 100.

The engagement analysis module 107 generates one or more engagement values based on the one or more measured engagement indicators (step 605). As described above in reference to FIGS. 2 and 3, the engagement analysis module 107 correlates context data and subject data to generate engagement values that can be expressed as vectors or can be individual engagement values associated with specific events or content in the media.

The adaptation module 109 selects content to be delivered to the subject 101 (step 607) based on engagement values associated with different tasks or events. In some implementations, the adaptation module 109 selects a category of content based on engagement values. For example, if a certain type of content, such as thrilling narrative elements in narrative media, are associated with a greater engagement value for a subject 101, that type of content can be selected by the adaptation module 109 to be delivered to the subject 101. As another example, the adaptation module 109 can select comedic or romantic content to be delivered to a subject 101 if that subject 101 displays higher engagement values with those types of content. As mentioned above, engagement values can be associated with entire works of media based on genre or modality. The adaptation module 109 can select content based on higher or lower engagement values associated with different genres or broad categories of media. The adaptation module 109 can also select modalities based on higher or lower engagement values associated with different modalities of media.

The content delivery module 103 delivers the content selected by the adaptation module 109 (step 609) and the indicator measurement module 105 can measure engagement indicators during the delivery of the selected content. In some implementations, the process goes through many iterations or is continuous, so the content delivery module 103 is continually or iteratively adapting the media content to the subject's 101 engagement.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The terms “computer” or “processor” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database 312 management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

What is claimed is:

1. An engagement-adaptive system comprising:
a content delivery module configured to deliver content to a user
a context logger configured to associate events in the delivered content with temporal locations in a first time-series;
an indicator measurement module configured to measure at least one engagement indicator during the delivery of content to the user and associate the measurements with a temporal location in a second time-series;
an engagement analysis module configured to generate at least one engagement value based on a calculated relationship between the first and the second time-series; and
an adaptation module configured to:
receive the at least one engagement value; and
modify execution of computer executable instructions by a processor based on the received engagement value.

2. The system of claim 1, wherein modifying execution of computer executable instructions comprises selecting content to be delivered to the user.

3. The system of claim 2, further comprising delivering the selected content to the user.

4. The system of claim 1, wherein measuring at least one engagement indicator comprises measuring at least one of: eye movement of the user, time taken by the user to respond to a stimulus, behavioral changes of the user, selections or choices made by the user, physiological attributes, or physiological changes of the user.

5. The system of claim 1, wherein the relationship between the first and second time-series is a dependency between first time-series and the second time-series, or the co-variation between the first time-series and the second time-series calculated by the function,
$$\frac{σ ( [ {V}_{indicator} ( t ) ] \cdot [ {V}_{context} ( t ) ] )}{σ ( [ {V}_{indicator} ( t ) ] )} ,$$
wherein V_{context}(t) is the first time-series and V_{indicator}(t) is the second time-series and σ is a variance function.

6. The system of claim 1, wherein the content is one of either audio-visual media or the output of an interactive program.

7. The system of claim 1, wherein the content delivery module is included in either a personal computing device or a mobile device.

8. The system of claim 1, wherein
delivering content to the user comprises delivering a set of educational concepts to the user; and
modifying execution of computer executable instructions comprises selection of educational concepts to be delivered based on higher or lower engagement values associated with educational concepts previously delivered to the user.

9. The system of claim 1, wherein
delivering content to the user comprises presenting a first task to the user; and
modifying execution of computer executable instructions comprises selection of a second task to be presented to the user based on higher or lower engagement values associated with the first or second task.

10. A method for engagement-based adaptation comprising:
delivering content to a user;
associating events in the delivered content with temporal locations in a first time-series;
measuring at least one engagement indicator of the user;
associating the measurements of engagement indicators with temporal locations in a second time-series;
generating at least one engagement value based on a calculated relationship between the first and second time-series; and
modifying the execution of computer executable instructions based on the at least one engagement value.

11. The method of claim 10, wherein modifying the execution of computer executable instructions further comprises selecting content to be delivered to the user.

12. The method of claim 11, further comprising delivering the selected content to the user.

13. The method of claim 10, wherein measuring at least one engagement indicator comprises measuring at least one of: eye movement of the user, time taken by the user to respond to a stimulus, temperature of the user, behavioral changes of the user, or physiological changes of the user.

14. The method of claim 10, wherein the relationship between the first and second time-series is a dependency between first time-series and the second time-series, or the co-variation between the first time-series and the second time-series calculated by the function,
$$\frac{σ ( [ {V}_{indicator} ( t ) ] \cdot [ {V}_{context} ( t ) ] )}{σ ( [ {V}_{indicator} ( t ) ] )} ,$$
wherein V_{context}(t) is the first time-series and V_{indicator}(t) is the second time-series and σ is a variance function.

15. The method of claim 10, wherein the content is one of either audio-visual media or the output of an interactive program.

16. The method of claim 10, wherein the content is delivered to the user by either a personal computing device or a mobile device.

17. The method of claim 10, wherein
delivering content to the user comprises delivering a set of educational concepts to the user; and
modifying execution of computer executable instructions comprises selection of educational concepts to be delivered to the user based on higher or lower engagement values associated with educational concepts previously delivered to the user.

18. The method of claim 10, wherein
delivering content to the user comprises presenting a first task to the user; and
modifying execution of computer executable instructions comprises selection of a second task to be presented to the user based on higher or lower engagement values associated with the first or second task.

19. Computer readable media storing processor executable instructions which when carried out by one or more processors, cause the processors to:
receive at least one measurement of at least one engagement indicator of a user associated with the delivery of content to the user;
associate events in the delivered content with temporal locations in a first time-series;
associate the measurements of engagement indicators with temporal locations in a second time-series;
generate at least one engagement value based on a calculated relationship between the first time-series and the second time-series,
wherein the relationship between the first and second time-series is a dependency between first time-series and the second time-series, or the co-variation between the first time-series and the second time-series calculated by the function,
$$\frac{σ ( [ {V}_{indicator} ( t ) ] \cdot [ {V}_{context} ( t ) ] )}{σ ( [ {V}_{indicator} ( t ) ] )} ,$$
wherein V_{context}(t) is the first time-series and V_{indicator}(t) is the second time-series and σ is a variance function; and
modify the execution of computer executable instructions based on the received engagement value.

20. The computer readable media of claim 19, wherein the instructions further cause the one or more processors to deliver content to a user.
